(19) United States
(12) Patent Application Publication
(10) Pub. No.: US 2026/0141681 A1
(43) Pub. Date: May 21, 2026

(54) METHOD AND DEVICE FOR INSPECTING GLASS CONTAINERS ACCORDING TO AT LEAST TWO MODES WITH A VIEW TO CLASSIFYING THE CONTAINERS BY THEIR GLASS DEFECTS

(71) Applicant: TIAMA, Saint-Genis-Laval (FR)

(72) Inventors: Olivier COLLE, Oullins (FR); Julien FOUILLOUX, Saint-Genis-Laval (FR); Sylvain GOURGEON, Mornant (FR)

(73) Assignee: TIAMA, Saint-Genis-Laval (FR)

(21) Appl. No.: 18/997,506

(22) PCT Filed: Jul. 21, 2023
(86) PCT No.: PCT/FR2023/051137

§ 371 Date: Jan. 21, 2025

(30) Foreign Application Priority Data
Jul. 22, 2022 (FR) FR2207555

(51) Int. Cl. G06V 10/764; G01N 21/88; G01N 21/90; G06V 10/10; G06V 10/14; G06V 10/26; G06V 10/75; G06V 10/98

(52) U.S. Cl. CPC G06V 10/764; G01N 21/8851; G01N 21/90; G06V 10/14; G06V 10/16; G06V 10/26; G06V 10/759; G06V 10/993; G01N 2021/8854

(57) ABSTRACT

The invention relates to a method for inspecting glass containers. The method includes inspecting each container using an inspection system so as to obtain at least one analysis image according to a first modality corresponding to an absorption image and at least one analysis image according to a second modality corresponding to a birefringence image or to a refraction image. The method includes defining a list of classes including at least glass defects. The method includes ensuring a matching of at least part of the analysis images according to the first modality and according to the second modality. The method includes classifying the analysis images by means of an image classifier that determines to what result class among the list of classes they belong. The method includes classifying the container according to the result class.

### TECHNICAL FIELD

The present invention relates to the technical field of the inspection of transparent or translucent containers such as for example glass bottles, jars or flasks, for the purpose of their quality control in order to detect and identify possible defects that may affect these containers.

The object of the invention finds particularly advantageous applications for analyzing physical characteristics of the containers so as to identify non-compliant physical characteristics corresponding to defects like for example surface defects such as folds or crevices, defects internal to the matter such as cracks, inclusions, or bubbles.

### PRIOR ART

For the manufacture of glass containers, it is known that the manufacturing process comprising the melting of the glass and then its conveying to forming units is implemented by means of a manufacturing facility comprising a melting furnace, a forecore for supplying molten glass to a forming machine generally of the type designated by IS machine. The containers that have just been formed by the forming machine are laid successively on an output conveyor to form a row of containers. The containers are transported in a row by a conveyor in order to be conveyed successively to different treatment stations. Particularly, the formed containers are brought into an annealing furnace, which raises their temperature and then cools them in a monitored manner so that the thermal stresses created by the forming procedure disappear. Other processes for forming glass containers are known for table glassware, insulators, syringes and bulbs. For example, there are forming machines such as rotary and sequential presses, and not in parallel aligned sections like IS machines. There are also machines that transform preforms into tubes, in particular borosilicate glass, to make syringes and bulbs dedicated to pharmaceutical products.

It is known to systematically inspect all containers leaving the forming machine, traveling on the output conveyor, using different inspection equipment, in particular systems for inspecting walls in transmission for which a light source is disposed on one side of the conveyor and at least one camera (typically at least two cameras) is disposed on the other side to acquire at least one image formed by the light transmitted through the walls of the container.

It is also known to systematically inspect all containers leaving the annealing furnace using different inspection equipment, in particular systems for inspecting walls in transmission for which a light source is disposed on one side of the conveyor and at least one camera (typically 2 to 6, 12 or 24) is disposed on the other side to acquire at least one image formed by the light transmitted through the walls of the container. Different equipment for inspecting walls in transmission is designed to acquire at least one image formed by the light transmitted through the vertical walls while some other equipment is adapted to acquire at least one image formed by the light transmitted vertically through the base of the container.

For example, patent EP2082216 describes a process for detecting, on the one hand, low-contrast defects particularly defects that refract light such as air bubbles, surface folds, or local variations in the thickness of the transparent material and, on the other hand, high-contrast defects particularly defects that absorb the through light such as inclusions of non-transparent matter or soiling. This process aims to drive a luminous source such that this source successively produces two types of lighting, the first type being homogeneous lighting while the second type is formed of alternating dark areas and light areas with a discontinuous spatial variation. Images of the traveling object are taken when the latter is successively lighted by the two types of lighting. The images taken with the lightings according to a first modality are analyzed so as to detect the high-contrast defects and the images taken with the lightings according to the second modality are analyzed so as to detect the low-contrast defects.

It is also known from patent EP 1 109 008, a method for analyzing the images of containers for cold inspection. A segmentation step detects features in the images and regions around the features. Discriminatory parameters of a region are calculated and combined with a fuzzy logic method to determine the type of the most likely features among a list of features corresponding to possible defects. The compliance of the region is then decided, by applying different criteria depending on the retained type of feature. For example, a fold-type defect will be ejected for a certain surface while an inclusion-type defect will be rejected even if it has a small surface. This patent teaches in particular that the defects do not all have the same criticality, which justifies seeking to determine their nature before deciding to reject a container. In this method, the lighting is a homogeneous extended source, which correctly reveals the absorbent defects, but in which the refracting defects are visible but with low contrast and therefore with insufficient sensitivity.

However, it appears difficult to identify with certainty some defects, particularly the “appearance defects”, i.e. the visual defects of all types: inclusions (of foreign bodies such as ceramics, metal), bubbles, folds, rivers (surface grooves), glazes (cracks), fins, trapezoids, grease stains, very thin areas, unmelted particles. These appearance defects appear in the images as local optical variations, or pixels with deviations from the background. These appearance defects can be critical if they lead to a risk for the consumer, a risk of breakage or a loss of functionality of the container. Since the recognition of an appearance defect from an image can be ambiguous, safety margins are taken during detection. It follows that containers are considered defective even though these containers are acceptable or compliant.

Moreover, it should be noted that acceptable artifacts such as engravings or decorations, weakly marked mold joints can be distinguished in the images. Also, there is a need to identify exactly the nature of the appearance defects in order to identify the critical defects by distinguishing them from the other defects. Preventing the critical defects requires improving the reliability of classification of the appearance defects. In addition to the fact that improving the defect identification improves the production efficiency, this identification of defects makes it possible to determine their potential causes so that the manufacturing facility can be driven according to the category of the detected defects. Indeed, without reliable identification of the detected defects, no safe decision to correct the manufacturing process can be made, whether manually or automatically.

Patent application WO2021213864 proposes a process for more reliably inspecting containers transported by a conveyor on a line, in particular a bottling. The containers are transported to at least a first inspection unit and a second inspection unit each including an emitter and a receiver. The inspection units can inspect the containers with white light, laser light, high-frequency electromagnetic waves, gamma rays and/or X-rays as emitters. The containers are transported between the emitter and a receiver such as a camera for acquiring first measurement data with the first inspection unit and second measurement data with the second inspection unit. According to this process, the first measurement data and the second measurement data are combined to form common input data for an evaluation unit based on the artificial intelligence and providing as output an inspection result such as a filling level.

As a single exemplary embodiment, this document describes the detection of the filling level of containers by combining X-ray imaging and the inspection with an infrared light source. This document specifies that such a process can be used to also check the side wall, the base, the mouth, the contents of the container such as for example contamination by foreign bodies or product residues. The result of the inspection can also be defects such as damage to the containers, in particular cracks and/or shards of glass.

However, patent application WO2021213864 does not provide any teaching to detect with certainty, the defects visible in transmission and in particular the appearance defects. Regardless of the obligation to detect these defects, it appears necessary to identify exactly the nature of the appearance defects to identify the critical appearance defects compared to the other defects that can be considered non-critical. An erroneous identification of a type of defect on a container can lead to the rejection of this container when a correct identification of this defect would have made it possible to identify the container as good. Thus, to improve the efficiency of sorting, it appears necessary to identify exactly the nature of the defects visible in transmission.

A container inspection device for increasing the reliability of detection, particularly to be able to reliably distinguish decorative elements from contamination or soiling is also known from patent application EP 3 679 356. The device includes a light source emitting in spatially separated areas, radiation with different wavelength and intensity ranges. This light source illuminates the container to be examined and a color camera is configured to detect the radiation emitted by the source and having crossed the container.

The device also includes an evaluation device designed to analyze the intensity image to determine therein pixels or regions that have an intensity different from that of their neighborhood to deduce therefrom the presence of a light-absorbing defect such as soiling. The evaluation device allows analyzing the color images to determine pixels or regions that have a different color from their neighborhood to deduce therefrom the presence of light-diffusing elements such as the decorative elements. Thus, if a brightness contrast is observed locally and at the same time if there is no color contrast in this area, the presence of contamination in this area is detected by the evaluation unit. If a local brightness contrast coincides with a local color contrast, the evaluation unit detects the presence of a decorative element.

The evaluation unit can also identify structures that cause a local color contrast but virtually no local brightness contrast or only a low local brightness contrast. For example, chips in the glass or water droplets can cause such a local color contrast, while the light shining through can radiate through these areas substantially without loss of brightness.

Such an inspection device allows distinguishing the decorative elements from soiling or contamination. In other words, the light-refracting defects are distinguished from light-absorbing defects. However, this inspection device does not allow distinguishing the light-refracting defects from each other, as indicated by this application, in particular with regard to glass inclusions and water droplets.

In the prior art, it is also known from WO2020/244815, a process for the optical inspection of containers, in which the containers are transported to an inspection unit including a lighting unit and a camera. The lighting unit emits light from a light emitting surface which is locally encoded on the basis of a polarization property, an intensity property and/or a phase property. By polarization property, it is understood in this document WO2020/244815 that the light emitted from the different emission points of the emission surface is emitted with different polarization directions. By polarization property, it is also understood in this document WO2020/244815 a linear, elliptical and/or circular polarization property. For example, a polarization filter with a continuously changing polarization curve or several polarization filters with different orientations can be disposed in the area of the light emitting surface.

According to one variant of embodiment, the light emitted by the light output surface is locally encoded on the basis of the polarization property, such as the polarization direction detected by the camera. It is possible to determine, independently of the radiation characteristic of the light output surface for the pixels of the image of the camera, from which radiation location the corresponding light part originates. Since the image processing unit exploits the image of the camera, at least one, to obtain information on the location of the radiation points, it is possible for example to distinguish a refracting defect on the basis of a local modification in the location of the radiation. Also, the information on the intensity can be exploited to detect the absorption of light by absorbing defects. However, this inspection device has the same drawbacks as the other known devices with regard to the impossibility of distinguishing a glass defect from another glass defect, both of which have, for example, a light-refracting nature.

Document EP 0 957 355 which describes a container inspection device aiming to detect opaque variations and stresses is also known from state of the prior art. In this device, a means for rotating a container about its axis, a light source with a diffuser and a polarizer, a first camera receiving the transmitted polarized light and a second camera receiving light passing through a second polarizer, are used. An image processing means is then used.

### DISCLOSURE OF THE INVENTION

The present invention aims to overcome the drawbacks of the prior art by proposing a method for monitoring the quality of glass containers, designed to achieve more effective detection of glass defects visible in transmission by ensuring their safe and certain identification in order to optimize the sorting of the containers.

Another object of the invention is to propose a method for monitoring the quality of the glass containers that allows, after the sure and certain identification of the nature of the glass defects, providing more complete information on the corrections to be made to the monitoring parameters of a glass container manufacturing process of a manufacturing facility.

To achieve such objectives, the object of the invention relates to a method for inspecting glass containers so as to classify a container, the method including the following steps:
inspecting each container using an inspection system including at least one light source illuminating the container and at least one camera disposed to recover the light having crossed the container, so as to acquire images of at least part of the container illuminated in transmission, so as to obtain at least one analysis image according to a first modality corresponding to an absorption image and at least one analysis image according to a second modality corresponding to a birefringence image or to a refraction image,
defining a list of classes including at least glass defects, the list of classes including a number of classes independent of the number of modalities;
ensuring a matching of at least part of an analysis image according to the first modality and at least part of an analysis image according to the second modality,
from at least one analysis image according to the first modality and at least one analysis image according to the second modality, matched together, classifying the analysis images by means of an image classifier that determines to what result class among the list of classes they belong,
the image classifier having been trained by supervised learning, on a learning set including recordings each composed of the images or image regions of the same container according to each modality, matched together and associated with a class from the list of classes, so that the trained image classifier ranks the containers according to classification characteristics according to the at least two modalities;
classifying the container according to the results class.

The object of the invention is based on a new approach for detecting on glass containers, glass defects visible in transmission. The method according to the invention takes into consideration the different interactions between the light and the matter and particularly, the absorption, the refraction and the birefringence in order to determine the physical nature of the defects. Taking these interactions into account in a combined manner allows making the identification of the defects visible in transmission more reliable.

One objective of the invention is to allow classifying the glass defects according to their physical characteristics by evaluating the modifications of the light transmitted through the wall of the containers, according to the absorption of the light and at least the refraction of the light and/or the modification of the polarization state of the light. These interactions are each more particularly highlighted according to the different observation modalities.

The invention is based on the idea that defects modify the transmitted light not according to a single type of modification, but by a variable combination of at least two types of modification.

Thus, an opaque foreign body such as a stone manifests itself by a certain absorption of the light, (modification of the intensity) but also by a modification of the state of polarization by the birefringence related to the stresses in the glass that surrounds it. An unmelted particle or devitrified glass will be transparent therefore poorly absorbent or non-absorbent, but will produce both refraction because it has a different index from normal glass, and a modification of the state of polarization by the birefringence related to the stresses it creates.

The invention increases the quality of classifying of the defects (or observed features) by the fact that defects can be:
similar according to a first type of modification of the light transmitted through the wall,
different if two types of modifications of the transmitted light are taken into consideration.

The invention thus increases the quality of classifying of the glass defects also because it is insensitive to the fact that the observation devices do not make it possible to highlight a single type of modification of the light transmitted through the wall. Indeed, when observing a container lighted by an extended luminous surface producing uniform illuminance, the image depends mainly on the absorption but also to a lesser extent on the refraction. This is due to the finite dimension of the luminous surface and to the fact that strongly refracting defects can cause an extinction of light by deflecting the light outside the pupil of the objective lens, this effect being not easily distinguishable from absorption. Thus, refracting defects appear in an absorption image.

Similarly, when observing a container lighted by an extended luminous surface producing illuminance that shows a spatial variation of a polarization property (a case of refraction image), the image depends mainly on the refraction but if a defect is birefringent, it also modifies the polarization property of the light. It follows that this observation modality is not sufficient to determine the nature of a defect.

In other words, the object of the invention aims to increase the quality of classifying of the containers according to the glass defects by the fact that it allows taking into account together, in combination, according to the intensity of at least two types of modifications of the transmitted light and according to morphological and photometric characteristics in different images of the defects, while overcoming the fact that no observation modality gives an independent estimation of a type of modification of the transmitted light.

According to one preferred variant implementing three inspection modalities, the method includes the following steps:
inspecting each container using the inspection system configured to acquire images so as to obtain at least one analysis image according to the first modality, at least one analysis image according to the second modality and at least one analysis image according to a third modality, the analysis image according to the second modality corresponding to a birefringence image while the analysis image according to the third modality corresponds to a refraction image,
ensuring a matching of at least part of an analysis image according to the first modality, at least part of an analysis image according to the second modality and at least part of an analysis image according to the third modality,
from at least one analysis image according to the first modality, at least one analysis image according to the second modality and at least one analysis image according to the third modality matched together, classifying the analysis images by means of an image classifier that determines to what result class among the list of classes they belong,
the image classifier having been trained by supervised learning, on a learning set including recordings each composed of the images or image regions of the same container according to each modality, matched together and associated with a class from the list of classes, so that the trained image classifier ranks the containers according to the classification criteria according to the at least three modalities,
classifying the container according to the result class.

According to a first exemplary embodiment of the inspection system, the method aims to inspect the containers using the inspection system configured to acquire images and to calculate, from several of these images, analysis images corresponding to absorption images, birefringence images and/or refraction images.

According to another exemplary embodiment of the inspection system, the method aims to inspect the containers using the inspection system configured to acquire polarimetric composite images and to calculate, from these polarimetric composite images, absorption images, and/or birefringence images and/or refraction images.

According to another exemplary embodiment of the inspection system, the method aims to inspect the containers using the inspection system configured to acquire, using a color camera, color composite images and to calculate, from these color composite images, absorption images and refraction images.

According to another exemplary embodiment of the inspection system, the method aims to inspect the containers using the inspection system configured to acquire images corresponding directly to absorption images, birefringence images and/or refraction images.

Advantageously, in order to ensure the matching of at least part of an analysis image according to the first modality and at least part of an analysis image according to the second modality and/or at least part of an analysis image according to the third modality, the method detects candidate regions in the analysis images of the first modality and in the analysis images of the second modality and/or in the analysis images of the third modality, the method ensuring, for each container:
a matching of the candidate regions in the analysis images of the first modality, the second modality or the third modality, with the corresponding regions of the analysis images of at least one other modality,
or a matching of candidate regions of two different modalities.

According to another advantageous example, the method ensures as a matching, a merging of at least one analysis image of the first modality and an analysis image of the second modality and/or an analysis image of the third modality to obtain a merged image, the method ensuring:
an extraction of classification characteristics from the merged image,
and a classifying of the container using classification criteria applied to the classification characteristics of the merged image.

According to another advantageous example, the method ensures, as a matching, a merging of at least one analysis image of the first modality and an analysis image of the second modality and/or the third modality to obtain a merged image, the method ensuring:
a segmentation of the merged images to detect merged candidate regions,
a classifying of the container using classification criteria applied to the characteristics of the merged candidate regions.

According to another characteristic of the invention:
classification characteristics according to the first modality are extracted from the analysis images according to the first modality,
classification characteristics respectively according to the second modality and according to the third modality are extracted from the analysis images according to the second modality and/or from the analysis images according to the third modality,
the container is ranked using classification criteria applied to the characteristics according to the first modality and the second modality and/or the third modality.

According to one advantageous variant, classification characteristics according to the first modality and classification characteristics according to the second modality and/or classification characteristics according to the third modality, and/or merged characteristics that take into account characteristics logically or mathematically combining analysis images according to the first modality and analysis images according to the second modality and/or analysis images according to the third modality are chosen, these classification characteristics according to the first, the second and the third modality being characteristics of position, size, shape or values expressing the absorption and/or the refraction and/or the birefringence.

According to one embodiment, the container is ranked by a supervised learning image classifier whose input data are:
the classification characteristics according to the first modality and the classification characteristics according to the second modality and/or the classification characteristics according to the third modality,
or the analysis images according to the first modality and the analysis images according to the second modality and/or the analysis images according to the third modality,
or parts of the analysis images according to the first modality and parts of the analysis images according to the second modality and/or according to the third modality.

According to another embodiment, the container is ranked by a supervised learning image classifier whose input data are at least one merged image obtained by merging of at least one analysis image according to the first modality and one analysis image according to the second modality and/or one analysis image according to the third modality or by merging of regions of at least one analysis image according to the first modality and one analysis image according to the second modality and/or one analysis image according to the third modality.

According to one preferred example, each container is ranked according to at least one class of images taken among a list of classes representing at least glass defects such as, in particular, trapezoid, inclusion, bubble.

According to another object of the invention, at least one sorting characteristic is compared with a rejection criterion, the sorting characteristic and the rejection criterion being dependent on the belonging class to decide whether the container is compliant or not, the sorting characteristic being calculated on at least one image of the container according to one modality.

According to one advantageous example, the method implements a step of taking into account at least one identified glass defect to deduce therefrom adjustment information for at least one monitoring parameter of a container manufacturing facility.

According to another characteristic of implementation of the process:
the image classifier associates a confidence score with the classifying of the containers forming part of an inspected production;
the classifying of the containers is taken into account only when the confidence score exceeds a confidence threshold to;
count the defects by class of defects;
and/or decide on the rejection of the container;
and/or trigger an alarm of presence of at least one critical defect in the inspected production.

Another object of the invention is to propose a device for inspecting glass containers leaving a manufacturing facility so as to classify the containers in relation to glass defects, the device including:
an inspection system including at least one light source illuminating the container and at least one camera disposed to recover the light having crossed the container, so as to acquire images of at least part of the container illuminated in transmission by the light source,
an information processing unit connected to the inspection system and adapted to provide for each container, at least one analysis image according to a first modality corresponding to an absorption image and at least one analysis image according to a second modality corresponding to a birefringence image or to a refraction image, this information processing unit being configured to carry out operations:
of taking into account a list of classes including representations of at least glass defects, the list of classes including a number of classes independent of the number of modalities;
of matching at least part of an analysis image according to the first modality and at least part of an analysis image according to the second modality, from at least one analysis image according to the first modality and at least one analysis image according to the second modality, matched together, of classifying the analysis images by means of an image classifier that determines to what result class among the list of classes they belong,
of taking into account the image classifier having been trained by supervised learning, on a learning set including recordings each composed of the images or image regions of the same container according to each modality, matched together and associated with an image class from the list of classes, so that the trained image classifier ranks the containers according to classification characteristics according to the at least two modalities;
of classifying the container according to the result class.

According to one embodiment of the invention, the inspection system is configured to acquire polarimetric composite images while the information processing unit is configured to calculate from these polarimetric composite images, absorption analysis images and/or birefringence analysis images and/or refraction analysis images.

According to another embodiment of the invention, the inspection system is configured to acquire images while the information processing unit is configured to calculate from several of these images, absorption analysis images and/or birefringence analysis images and/or refraction analysis images.

According to another embodiment, the inspection system is configured to acquire color composite images using a color camera while the information processing unit is configured to calculate from these color composite images, absorption images and refraction images.

According to another embodiment, the inspection system is configured to acquire images corresponding directly to absorption images, birefringence images and/or refraction images.

Various other characteristics emerge from the description given below with reference to the appended drawings which show, by way of non-limiting examples, embodiments of the object of the invention.

### BRIEF DESCRIPTION OF THE DRAWINGS

FIG. 1 is a simplified view of a device in accordance with the invention for inspecting glass containers leaving a manufacturing facility.

FIG. 2 represents one exemplary embodiment of a system for acquiring images by polarimetric camera, for the containers leaving a manufacturing facility and implemented in the inspection device in accordance with the invention.

FIG. 3 illustrates one example of a composite pixel obtained by a polarimetric camera of the inspection system illustrated in FIG. 2.

FIG. 4 represents another exemplary embodiment of an image acquisition system for the containers leaving a manufacturing facility and implemented in the inspection device in accordance with the invention.

FIG. 5 is a simplified functional block diagram of one example of a first embodiment of the inspection device in accordance with the invention, implementing a processing called conventional processing of the information contained in the analysis images according to a first modality and in the analysis images according to a second modality.

FIG. 6 is a simplified functional block diagram of one example of a first embodiment of the inspection device in accordance with the invention, implementing a segmentation operation on a merged image obtained by the matching of an analysis image according to a first modality and an analysis image according to a second modality.

FIG. 7 is a simplified functional block diagram of one example of a first embodiment of the inspection device in accordance with the invention, implementing a convolutional neural network having as input data, matched candidate regions resulting from operations of segmenting an analysis image according to a first modality and an analysis image according to a second modality.

FIG. 8 is a simplified functional block diagram of one example of a first embodiment of the inspection device in accordance with the invention, implementing three convolutional neural networks having as input data, a candidate region resulting from a operation of segmenting an analysis image according to a first modality, an analysis image according to a second modality and an analysis image according to a third modality.

FIG. 9 is a simplified functional block diagram of one example of a second embodiment of the inspection device in accordance with the invention, implementing a convolutional neural network having as input data, a merged image of an analysis image according to a first modality and an analysis image according to a second modality.

FIG. 10 is a simplified functional block diagram of one example of a second embodiment of the inspection device in accordance with the invention, implementing convolutional neural networks having as input data, all or part of an analysis image according to a first modality and an analysis image according to a second modality, without prior segmentation.

### DESCRIPTION OF EMBODIMENTS

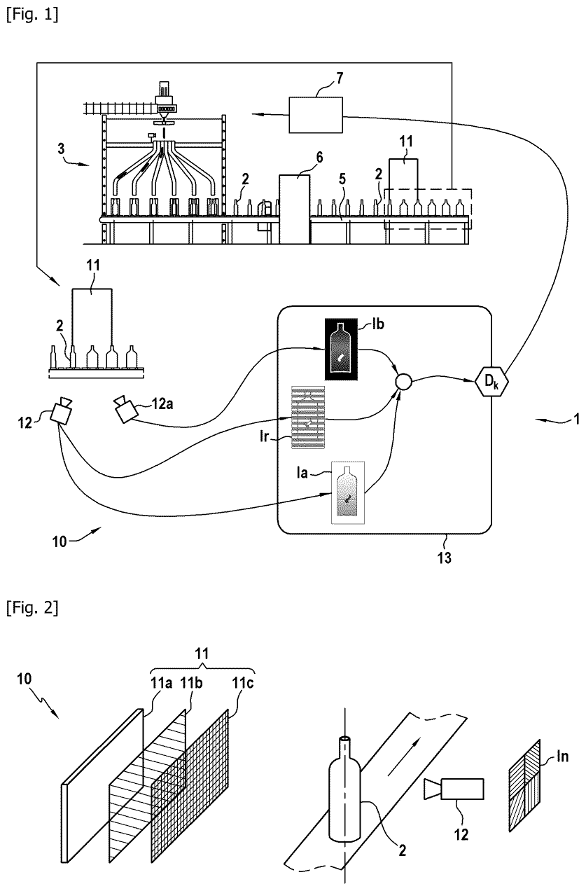

FIG. 1 illustrates a device 1 in accordance with the invention for inspecting glass containers 2 leaving a manufacturing or forming facility 3 of all types known per se. The inspection device 1 aims to detect for each container, whether the container has a glass defect and to identify for a container having a glass defect, a type of defect among a family of possible glass defects.

At the outlet of the manufacturing facility 3, the containers 2 such as in the example illustrated, glass bottles or flasks, have a high temperature typically comprised between 300° C. and 600° C. In a known manner, the containers 2 that have just been formed by the facility 3 are supported by an output conveyor 5 to form a row of containers by being, in the example illustrated, laid successively on the output conveyor. The containers 2 are transported in a row by the conveyor 5 along a transfer direction in order to be conveyed successively to different treatment stations and particularly an annealing lehr 6 upstream of which a coating hood, not represented, generally constituting the first of the treatment stations after forming, is placed. Advantageously, the inspection device 1 in accordance with the invention inspects the containers downstream of the annealing lehr 6. It may be provided that the inspection device 1 in accordance with the invention is installed upstream of the coating hood or between the coating hood and the annealing lehr 6.

The manufacturing facility 3 is known per se and one example will be described briefly to allow only an understanding of the interaction between the inspection device 1 in accordance with the invention and the manufacturing facility 3.

The manufacturing facility 3 includes a production calculator 7 for supervising the different functionalities of the manufacturing facility 3. The calculator is typically a sequencer that controls pneumatic or motorized actuators as well as valves monitoring the circulation of the cooling air or the blowing pressure. Conventionally, the manufacturing facility 3 includes several distinct forming sections operating in parallel and successively delivering at least one glass container. In the example of the IS machine, the different distinct forming sections each include at least one blank mold receiving a glass parison and at least one blow mold. In a known manner, it is possible to identify the forming section, the blank mold and the blow mold from which each container 2 comes, the order of travel of the containers being known for a given production until the containers enter the annealing lehr 6. When the inspection device 1 in accordance with the invention is installed downstream of the annealing lehr 6, it can be provided to equip it with a device for reading information carried on the containers and indicating the mold or the original section of the containers and/or a timestamp of their manufacture. Alternatively, it may be proposed that the inspection device 1 is connected and synchronized with the information reading device located in the vicinity of the inspection line.

The inspection device 1 in accordance with the invention includes an inspection system 10 including at least one light source 11 illuminating the container 2 and at least one camera 12, 12a, ... disposed to recover the light having crossed the container, so as to acquire images of at least part of the container illuminated in transmission by the light source 11. The camera 12, 12a generally includes an objective lens having an optical center and an optical axis, and a linear or matrix photoelectric, generally planar, positioned in the focal plane. The inspection system 10 is connected to an electronic information processing unit 13. This electronic information processing unit 13 is a computer system of all types including computers, external peripherals (display unit, storage unit, keyboards, connection to different factory networks, ...) , programs implementing in particular image processing algorithms, databases, etc.

This information processing unit 13 is connected to the production calculator 7 in order to receive, if necessary, from the production calculator, time information making it possible to associate the containers 2, their images and their detected defects with the mold number or the forming cavity. Typically, the operation of the inspection system 10 is synchronized with the operation of the container forming cavities.

Moreover, this information processing unit 13 transmits the identified glass defects and the taken measurements to the production calculator 7, so that the production calculator can automatically deduce adjustment information for at least one monitoring parameter of the manufacturing facility 3. Such an adjustment of the monitoring parameters is carried out manually or automatically. Finally, the information processing unit 13 is connected to an ejector to control the ejection of containers identified as defective, and/or to a display unit to present to an operator the identified glass defects and the images of the containers.

The inspection system 10 is configured to recover the light coming from the light source 11 and having crossed the container in order to acquire images in the general sense, of at least a part of the container illuminated in transmission. In accordance with the invention, these images are obtained according to at least two different inspection modalities corresponding to different interactions of the light with the wall of the containers and with the glass defects to be identified. According to one variant of embodiment, the inspection system 10 is configured to obtain images according to two different inspection modalities. According to one preferred variant of embodiment, the inspection system 10 is configured to obtain images according to three different inspection modalities.

The first inspection modality is called absorption modality. This first modality mainly highlights the absorption of the through light by the wall crossed by the container. Some defects have a totally or partially absorbent nature. These defects thus appear opaque or dark when seen in transmission, that is to say the light crossing a glass wall without defects undergoes an absorption called normal absorption corresponding to the hue and thickness, assumed to be homogeneous, of the glass wall. But the absorbent defects present a local anomaly with an absorption sometimes lower (bubble or thin spot) but generally higher than the normal absorption. In the following, absorption will only refer to the abnormal absorption of the absorbent defects. Such defects include in particular inclusions in the glass, in particular ceramic or metal inclusions, and/or soiling (grease, etc.) on the glass. But such defects also include some glazes (cracks) that would be oriented in the glass so as to block the inspection light, mainly because the inspection light is then reflected in a direction that is not seen by the camera.

The second inspection modality is called birefringence modality. This second modality mainly implements a modification of the polarization state of the light crossing the wall of the container by a defect called stress defect, which gives the glass a birefringence property. Some defects have a birefringent nature. Thus, some defects are reflected by the presence of residual mechanical stresses in the material (sometimes called internal mechanical stresses). In the wall, a birefringent or stress defect, such as an inclusion of foreign bodies (ceramic, metal, “devitrified glass”) causes a modification of the polarization state, that is to say a polarization phase shift between two components of the electric field or a modification of the direction of linearly repolarized light.

The third inspection modality is called refraction modality. This third modality mainly implements a modification of the direction of propagation of the light crossing the wall of the container by a refracting defect, due to an angle between the crossed dioptric surfaces but also to a difference in the refractive index. Each surface is an air/glass or glass/air interface, therefore a diopter that refracts the light crossing it. In the absence of defect, the surfaces of the walls are substantially parallel and the refraction does not cause any visible deviation of the luminous rays crossing the container. A defect called refracting defect is a defect that locally causes abnormal refraction, mainly when the defect appears by slope deviations between surfaces or diopters of the wall(s). Reference will therefore be made to refractive defect only to designate deviations of the light by the particular refraction at the level of the defects called refracting defects. The refractive defects are defects that are mainly detectable by the refraction anomalies they generate, in particular in a through-light inspection. Typically, the surface defects (folds, rivers,) or glass distribution defects (blisters, thin spots, compression ring), the trapezoids and the fins are generally ranked among the refractive defects. It should be noted that the trapezoids and the fins generally cause such strong refractions that these defects are generally clearly visible also in the absorption images.

When the invention implements two modalities, the first modality is the absorption modality while the second modality is the birefringence or refraction modality. When the invention implements three modalities, the first modality is the absorption modality, the second modality is the birefringence modality and the third modality is the refraction modality.

In a known manner, the inspection of the containers 2 according to these different inspection modalities can be carried out using various configurations of the inspection system 10. It is considered that the inspection system 10 is configured to acquire images so as to obtain images called analysis images according to either or both of the three modalities above. Indeed, depending on the inspection system 10 used, the analysis images according to these modalities can be obtained directly from the acquired images or from calculations or processing operations. Thus, the inspection system 10 associated with the processing unit 13 make it possible to obtain:
an analysis image according to the first modality, called in the remainder of the description, absorption image Ia, composed of absorption pixels whose value mainly represents the absorption of the through light by the crossed wall;
an analysis image according to the second modality, called in the remainder of the description, birefringence image Ib, composed of birefringence pixels whose value mainly represents a modification of the polarization state of the light crossing the wall of the container;
an analysis image according to the third modality, called in the remainder of the description, refraction image Ir, composed of refraction pixels whose value mainly represents a modification of the direction of propagation of the light crossing the wall of the container.

The remainder of the description describes, by way of non-limiting example, various methods for obtaining absorption images Ia, birefringence images Ib and refraction images Ir. It is recalled that in all the methods that follow, a light source illuminates the inspected region of the container in transparency, with observation of the light source in the background of the container.

To obtain absorption images Ia, a first simple method is to produce on the light source a non-polarized intensity uniform lighting in an active portion. A second solution for obtaining the absorption image is to use a linearly or circularly polarized intensity uniform light source and to make the image by means of a camera without any polarizer filter between the container and the camera. The intensity uniformity of the light source can be perfect, that is to say the intensity is constant over the entire active area of a planar and extended light source emitting diffuse light. The uniformity can also be local, particularly when the glass of the containers is tinted, it can be provided that a region of the source lighting the neck where the glass wall is thicker, emits a stronger uniform intensity while a region lighting the body of the container where the wall is thinner, emits a weaker uniform intensity. Is also considered as uniform or relatively uniform, the intensity of a light source that generates as described in document FR 2794241, a continuous spatial variation of intensity slower than the one observed in the vicinity of a defect, so that an image analysis algorithm which compares the pixels with their neighbors to detect rapid local intensity variations as defects does not detect the slow intensity variations emitted by the source.

Another solution for obtaining the absorption image is described in patent application EP 3 679 356, which proposes to produce an illumination with a source whose color varies spatially and acquire a composite image (RGB) which is transformed into the HSV (Hue, Saturation, Value) color representation space. The absorption image is obtained by the V image or a transformation of this image is obtained for example by means of a gradient calculation. It should be noted that a refraction image is obtained by the H image, or a transformation of this image is obtained for example by means of a hue gradient calculation.

Another solution for obtaining the absorption image is to use a linearly or circularly polarized monochrome intensity uniform light source and to make a composite polarimetric image by means of a polarimetric camera, and to calculate the absorption image from at least two partial polarimetric images corresponding to observations through two linear filters of analysis directions at 90° to each other.

Another solution for obtaining an absorption image is to produce the illumination using a source having variations of a polarization characteristic with the intensity remaining relatively uniform and to acquire a composite image containing at least 2 to 4 partial images using a polarimetric camera and to calculate an absorption image from 2 to 4 partial images taken through polarization analyzers at 90°to each other.

The following description describes a method for obtaining, with a single inspection system and a single raw image acquisition, on the one hand an absorption image and on the other hand a refraction image. The inspection system comprises, as illustrated in FIG. 2, a diffuse extended light source 11 composed of elementary sources 11a that can be driven independently of each other, such as LEDs. The light source 11 also includes a linear polarizer filter 11b and a matrix of liquid crystal cells 11c for modifying the polarization properties of the light emitted for each elementary source. The light source 11 is therefore composed of elementary sources that can be driven in intensity and according to a polarization property such as the polarization direction.

By these means, the light source 11 is able to present on an active area lighting a region of the container 2 to be inspected in transmitted light, a function of variation of a polarization property according to any desired spatial variation function. The polarization property is, according to one variant of embodiment, the polarization direction. Preferably, the light source 11 has a variation of the polarization property according to a piecewise continuous periodic law, preferably a symmetrical triangular function.

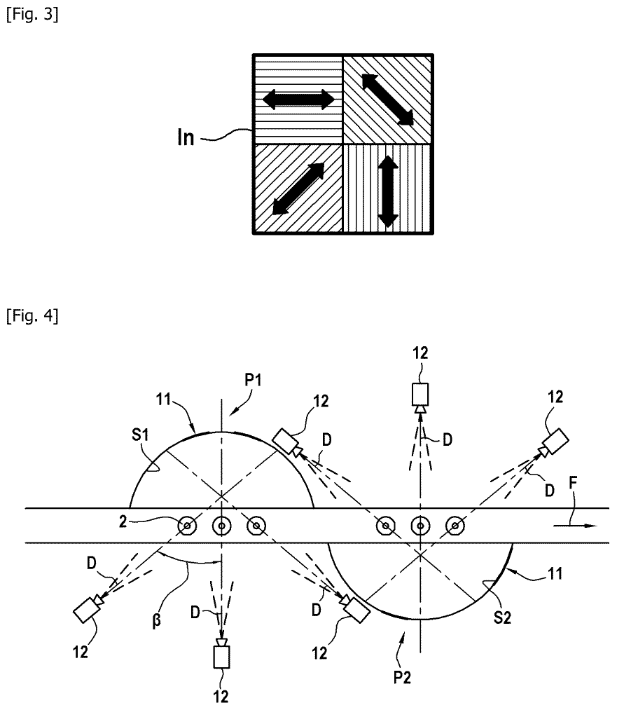

A polarimetric camera 12, through its photoelectric sensor, delivers a composite digital image In, which includes a set of composite pixels. Each composite pixel is a group of 4 partial pixels juxtaposed as illustrated in FIG. 3. In front of each of the 4 partial pixels of each composite pixel, an individual linear polarizer filter is placed, each having the four linear polarization directions oriented respectively at 0°, 45°, 90° and 135°. By grouping together the partial pixels of each composite pixel with a polarizer filter of the same orientation, four partial images filtered by linear filters 0 °, 45°, 90°, 135° can be obtained that is to say the images I0 I45 I90 I135, with pixels I0(x, y) I45(x, y) I90(x, y) and I135(x, y).

To calculate the absorption image, each pixel IAbs(x, y) is obtained by adding or averaging 2 by 2 at least two partial pixels corresponding to two directions of the polarizer at 90°.
IAbs (x, y)=I0(x, x)+I90(x, y) or
IAbs (x, y)=I45(x, x)+I135(x, y) or
IAbs (x, y)=½(I45 (x, x)+I135(x, y)+I0(x, x)+I90(x, y)) To obtain the refraction image Iref(x, y), the polarization direction of the light received by the camera a(x, y) is calculated for example by means of the Stokes parameters.

A first formula for calculating a value of the received polarization orientation a(x, y) from the values of two partial pixels can be written:

$$IRef ( x , y ) = α ( x , y ) = arc tan \sqrt{\frac{I 90 ( x , y )}{I 0 ( x , y )}}$$

Or even from the 4 pixels:

$$IRef ( x , y ) = α ( x , y ) = \frac{1}{2} atan ( \frac{I 45 ( x , y ) - I 135 ( x , y )}{I 0 ( x , y ) - I 90 ( x , y )} )$$

Since the polarization direction variation is triangular periodic, it can be observed that in the absence of refraction, therefore for a wall without defects with the theoretically parallel faces, the polarization orientation a(x, y) is half the phase of the triangular periodic signal φ=2a. The measurement of the direction is equivalent to the measurement of the phase. A local phase deviation is directly proportional to the refraction since the variation function is for example symmetrical triangular and therefore linear almost everywhere.

To obtain birefringence images Ib, a first simple method is to produce on the light source, a linearly polarized monochrome uniform lighting along a direction P1, in an active portion. The image is acquired either by a black and white camera in front of which is placed a linear polarization analyzer whose direction is orthogonal to the direction P1, or by a polarimetric camera whose pixels of the partial image corresponding to the analysis are taken into account through a linear filter orthogonal to the direction P1. The value of the pixels of the birefringence image is then almost zero except in the presence of a stress defect. When the light crosses a stress defect, the luminous intensity obtained depends on the direction and the intensity of the stresses.

A second method is to obtain a birefringence image Ib and to produce on the light source, a circularly polarized monochrome uniform lighting along a way S1 in an active portion. The image is acquired with a black and white camera in front of which is placed a ¼ wave retardation plate then a linear polarization analyzer. The value of the pixels of the birefringence image is then almost zero except in the presence of a stress defect. When the light crosses a stress defect, the luminous intensity obtained depends on the intensity of the stresses but not on the direction of the stresses.

A third method for obtaining a birefringence image Ib is to produce on the light source, a monochrome uniform lighting polarized linearly along a single direction or circularly along a single way in an active portion. The image is acquired by a polarimetric camera in front of which a ¼ wave retardation plate delivering a composite image is optionally placed. A birefringence quantity which depends on the polarization phase shift between the components Ex and Ey of the electric field and which is a measurement of the stress is calculated from 2 or 4 partial images. Those skilled in the art will be able to find the calculation formulas from the Mallus equation and the Stokes formalism. The polarization phase shift can be calculated to obtain as pixel values in the birefringence image, a value that depends on the intensity of the stresses but preferably not on the direction of the stresses, the detection is therefore isotropic and proportional to the stresses. According to one of these variants, the polarization phase shift can be measured between 0 and 90° or even between 0 and 180°. This method also allows calculating an absorption image Ia with the composite image delivered by the same polarimetric camera, by calculating each pixel IAbs(x, y) as explained previously.

To obtain refraction images Ir, a first method for obtaining a refraction image is illustrated in patent U.S. Pat. No. 4,606,634, which describes a type of refracting defect detection that consists in modifying the “angular spectrum” of an extended light source. A light source of variable dimension, for example a luminous disk of variable diameter, is at the focus of a converging projection lens. In the image obtained using a camera that receives the light having crossed the container, an enhanced contrast is obtained on the refracting objects, this contrast being able to be increased by reducing the angular spectrum, which is produced by reducing the diameter of the luminous disk.

A second set of methods for obtaining a refraction image consists in varying spatially along the emitting surface of an extended light source, such as a luminous panel, a property of the light emitted by the source that the camera knows how to distinguish. As a property of the light that varies spatially, its intensity was initially used. At least one image is acquired with an intensity-sensitive camera, therefore a priori monochrome, delivering monochrome images. The intensity of light emitted by each unit of light-emitting surface varies spatially according to a spatial variation law in one or two dimensions. In other words, these inspection processes adapted for the detection of refracting defects implement illumination devices that provide light sometimes called “structured” light, that is to say having a generally two-dimensional emitting surface that has variations or intensity patterns.

These methods include a large number of variants with regard to its variation law and the possible measurement of the property by means of one or more cameras. The spatial variation law is unidirectional or bidirectional. In the bidirectional case, it can be expected that the property is distributed according to a regular checkerboard-type pattern. It is more common for the spatial variation law to be unidirectional in a vertical, alternately oblique or horizontal, direction. It is moreover possible to make and analyze images with a vertical spatial variation law, then make and analyze images with a horizontal spatial variation law. These images can also be combined. The spatial variation law can be uniform and continuous over the entire inspected region. For example, documents US4487322, EP0344617, EP1006350, EP2082216, EP2558847, EP3552001 and EP2875339 describe various variants of these methods.

A third set of methods for obtaining a refraction image consists in varying spatially along the emitting surface, as a property of the light emitted by the source, a polarization property, a color property and/or a phase property. As an example, documents WO2020/244815 and EP3679356 illustrate variants of this third set of methods for obtaining a refraction image.

It appears from the examples given above that the inspection method using the inspection system 10 associated with the electronic information processing unit 13 makes it possible to obtain absorption images Ia, birefringence images Ib and refraction images Ir, according to different methods summarized below.

Thus, the method according to the invention aims to inspect the containers 2 using the inspection system 10 configured to acquire images and to calculate from several of these images and thanks to the electronic information processing unit 13, analysis images corresponding to absorption images Ia, birefringence images Ib and/or refraction images Ir.

According to another method, the method aims to inspect the containers 2 using the inspection system 10 configured to acquire polarimetric composite images and to calculate from these polarimetric composite images, absorption images Ia and/or birefringence images Ib and/or refraction images Ir. The inspection system 10 can be configured to acquire color polarimetric composite images or monochrome polarimetric composite images.

According to another method, the method aims to inspect the containers 2 using the inspection system 10 configured to acquire, using a color camera, color composite images and to calculate from these color composite images, absorption images Ia and refraction images Ir.

According to another method, the method aims to inspect the containers 2 using the inspection system 10 configured to acquire images corresponding directly to absorption images Ia, birefringence images Ib and/or to refraction images Ir.

The objective of the combination of these various lighting and image acquisition techniques is to obtain from each inspected region of each container, at least two and preferably at least three images each according to a different modality with, for each modality, the value of each pixel that depends on a different modality of interaction of the light with the crossed wall and with the defects to be detected. Of course, the configuration of the lighting and of the cameras depends on the inspected region of the container which can correspond to the body, the base, the collar, the shoulder, the chime, the finish or an area where engravings are present for example.

FIG. 4 illustrates by way of example, the positioning of cameras 12 with observation directions distributed about the vertical axis of the container 2 to guarantee an inspection of the entire periphery of the container. According to this example, the inspection system 10 includes two inspection stations distributed along the path of the containers 2. The first inspection station P1 includes a light source 11 disposed along a first side of the trajectory and having a concave-shaped emitting surface S1 composed of a plurality of elementary luminous sources controlled so as to define three lighting areas having a first identical lighting configuration and a second identical lighting configuration. This first inspection station also includes three cameras 12 disposed along a second side of the trajectory opposite to the first side and with optical axes D of different directions centered on the lighting areas.

The second inspection station P2 includes a light source 11 disposed along the second side of the trajectory and having a concave-shaped emitting surface S2 composed of a plurality of elementary luminous sources controlled so as to define three lighting areas having a first identical lighting configuration and a second identical lighting configuration. This second inspection station includes three cameras 12 disposed along the first side of the trajectory and with optical axes of different directions centered on the lighting areas.

The light sources and the cameras are controlled, when a moving container 2 is successively substantially centered on an observation direction, of each of the cameras 12, to acquire images of the container illuminated by the associated lighting area controlled to switch on successively during the acquisition, according to the first lighting configuration and the second lighting configuration. For each container, six images can thus be obtained with six observation directions according to a first modality (absorption for example) and six images can be obtained with six observation directions according to a second modality (birefringence modality for example).

Regardless of the implemented inspection system, the information processing unit 13 is adapted to provide analysis images according to the first modality (absorption image) and analysis images according to the second modality (birefringence image or refraction image), even images according to the third modality according to the preferred variant of embodiment. Moreover, in accordance with the invention, this information processing unit 13 is configured to perform operations:
of taking into account a list of classes including at least glass defects, the list of classes including a number of classes independent of the number of modalities;
of matching at least part of an analysis image according to the first modality and at least part of an analysis image according to the second modality even according to the third modality,
from at least one analysis image according to the first modality and at least one analysis image according to the second modality or even the third modality, matched together, of implementing an image classifier to classify the analysis images in order to determine to what result class among the list of classes they belong,
of taking into account the image classifier having been trained by supervised learning, on a learning set including recordings each composed of the images or image regions of the same container according to each modality, matched together and associated with a class from the list, so that the trained classifier ranks the containers according to classification characteristics according to the at least two modalities,
of classifying the container according to the result class.

The information processing unit 13 is thus adapted to implement an inspection method for detecting defects on containers and classifying the containers, according to previously defined classes.

According to one characteristic of the invention, the method aims to define a list of p classes D1, D2, ... Dk, ... Dp including at least glass defects, that is to say defects related to the container manufacturing procedure. The glass defects concerned are glass defects having optical properties of interaction with the light crossing the container, such as at least a part of absorption, and/or a part of birefringence and/or a part of refraction, so that they are detectable by means of the aforementioned devices. For a part of this list, each class corresponds to a glass defect. For example, these classes can correspond to a bubble, an inclusion, a fold, a grain, a stone, a fin, a large blister, a trapezoid or a birdswing. Moreover, several classes can correspond to the same type of glass defect, such as a trapezoid-type glass defect. According to this example, one class can correspond to large trapezoids with thick glass threads and another class can correspond to small trapezoids with small unconnected tips. These classes are given for illustrative purposes only.

For another part of this list, some classes correspond to image artifacts that do not correspond to defects. Thus, classes can correspond to reliefs with a technical function such as positioning marks or the striations on the laying plane, with a decorative function such as coats of arms, or with a function of technical or commercial indications such as brand, capacity, mold number. Other classes can correspond to distinguishable elements on the container such as mold joints, which may be circular at the base or linear on the vertical wall. The recognition of a mold joint in the image, therefore the classifying of an image element as a mold joint, then allows a specific analysis in order to determine whether the mold joint is weakly marked, which is not a defect, or strongly marked which requires the ejection of the container carrying such a mold joint.

Advantageously, it is possible to associate with each class from the list of classes, a criticality, that is to say a high value for a class of critical defects such as a trapezoid, lower for a class of less critical defects such as a fold, even lower for a non-defect object class such as a mold joint.

It should be noted that the number p of image classes is independent of the number of modalities. Generally, the list of classes includes a number of classes greater than the number of implemented modalities. Moreover, the list of classes can include classes that do not correspond to glass defects. For example, the list can include as a class that does not correspond to glass defects, a class corresponding to a container 2 without defects, a class corresponding to a container 2 with a mold joint, a class corresponding to a container 2 with a coat of arms. According to one advantageous variant of embodiment, the list of classes contains a non-glass defect class, at least one trapezoid class, at least one inclusion class, and at least one bubble class. These classes are recorded and accessible to the information processing unit 13.

The number of classes is therefore determined first by the need for production and quality control, therefore by the need to identify the production defects in order to make the right decisions during sorting and to allow possible correction of the process. Conversely, the number of modalities is only determined by the technical and economic limits of the known means for highlighting the absorption, refraction and birefringence properties. According to the prior art described by patent application EP 3 679 356, the reasoning based on a priori knowledge from those skilled in the art of the optical interactions of defects according to two modalities A and B, leads to predicting a determined number of classes by the number of modalities, namely in this example only four classes: A and B, A and not B, not A and B, A strong and B weak.

The number of classes also depends on the quality of sorting obtained by means of a supervised image classifier. Indeed, during the training of the image classifier, it is known to verify on test sets, the rate of good classifyings obtained. It has been observed that the classifying is better when the list of classes contains several classes for the same defect such as trapezoids. In other words, the number of classes can be increased to improve the quality of the automatic classifying.

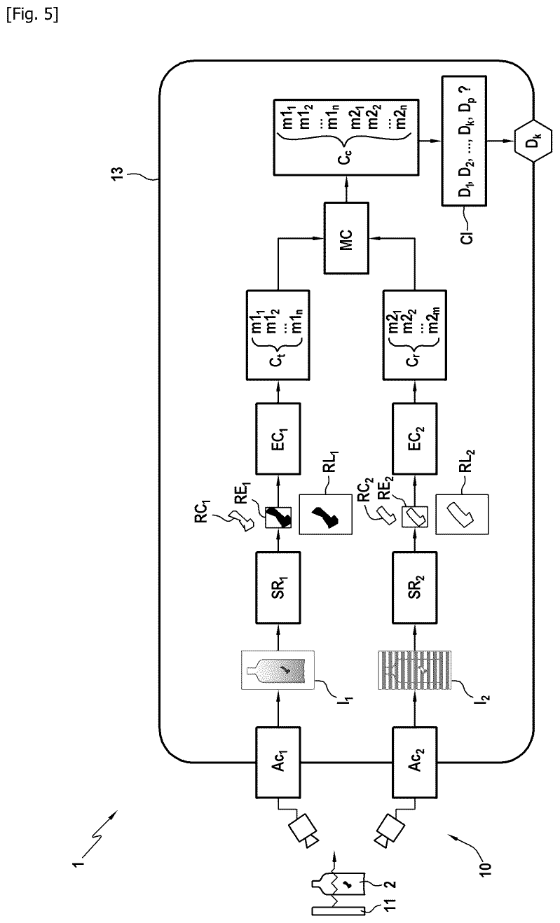

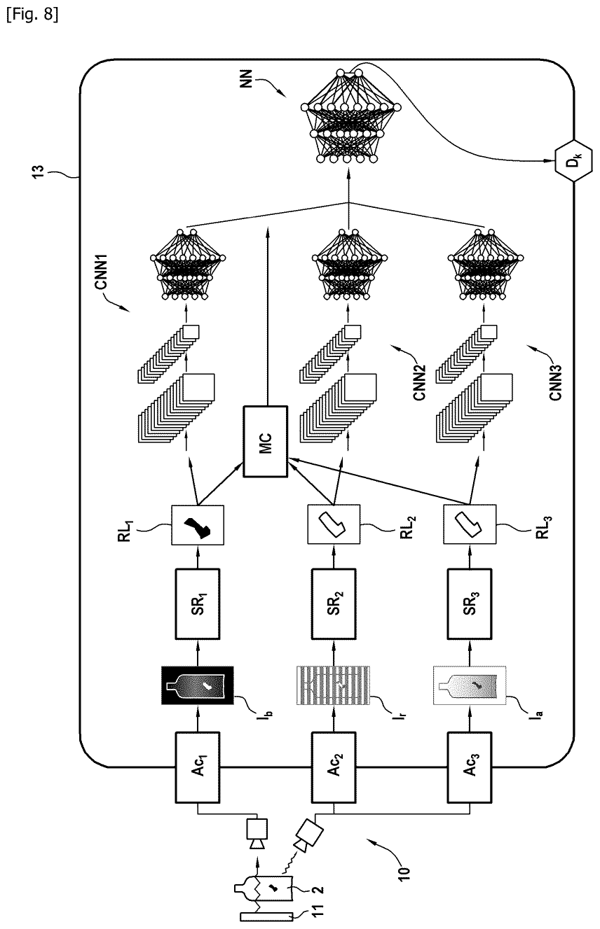

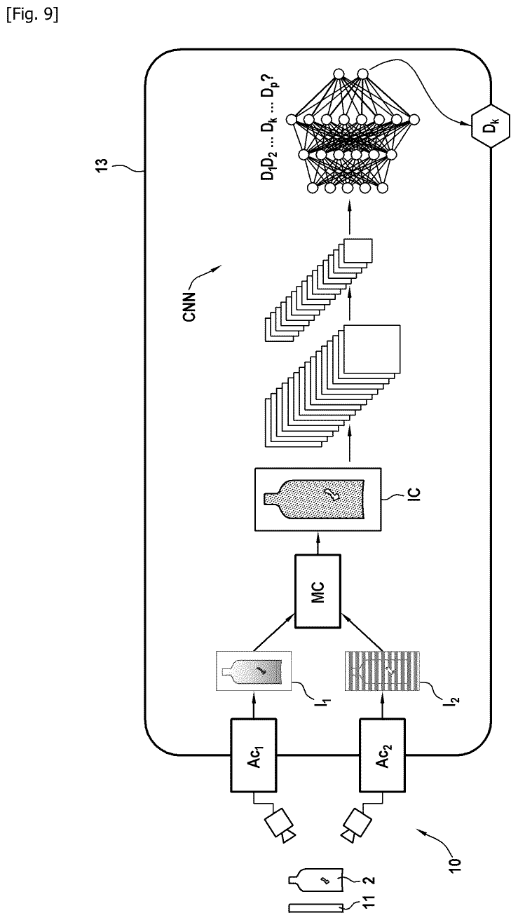

As can be seen from FIGS. 5 to 10, the inspection method according to the invention consists, for each container 2, in implementing at least one acquisition operation Ac1 to obtain at least one analysis image according to the first modality and one acquisition operation Ac2 to obtain at least one analysis image according to the second modality. In the example illustrated in FIG. 8, the inspection method according to the invention also consists, for each container 2, in implementing an acquisition operation Ac3 to obtain an analysis image according to the third modality. As explained above, the absorption, birefringence and refraction images can be obtained directly. Thus, the absorption, refraction and birefringence images are identical to the acquired images.

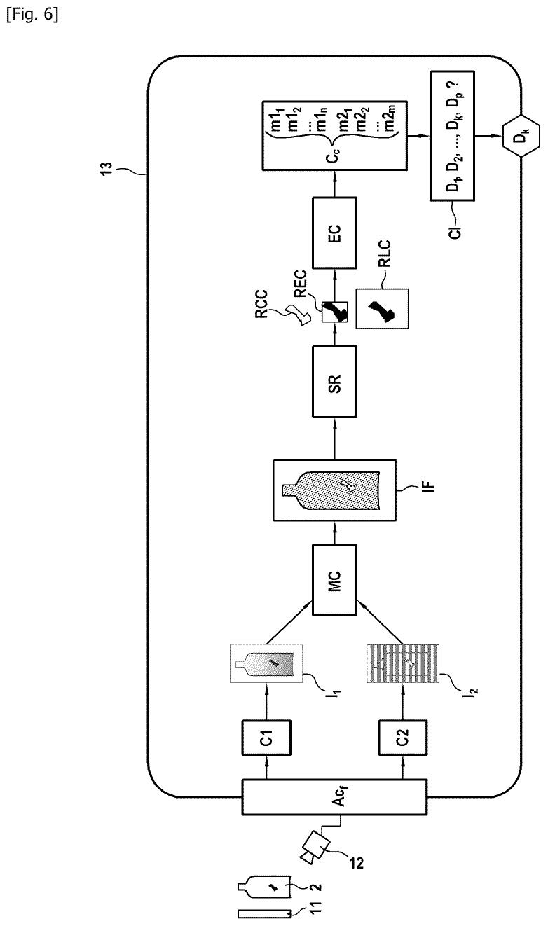

The absorption, birefringence and refraction images can also be obtained by calculation operations performed on the acquired images. In the example illustrated in FIG. 6, a polarimetric camera or a color camera allows the acquisition ACf respectively of a polarimetric composite image or a color image. From this composite image, calculation operations C1, C2 are performed to obtain an analysis image according to the first modality and an analysis image according to the second modality. Thus, with a uniformly polarized luminous source, it is possible to obtain an absorption image and a birefringence image while with a luminous source with a variation in the direction of polarization, an absorption image and a refraction image can be obtained.

The method according to the invention then consists in ensuring an operation of analyzing the images including an operation or a step of matching MC at least part of the analysis image according to the first modality and at least part of an analysis image according to the second modality and possibly at least part of an analysis image according to the third modality. The method then consists in implementing a classification or classifying step CI, using an image classifier, from the information contained in at least the analysis image according to the first modality and the analysis image according to the second modality and possibly the analysis image according to the third modality, matched together, in order to classify the container, in a result class Dk forming part of the list of classes.

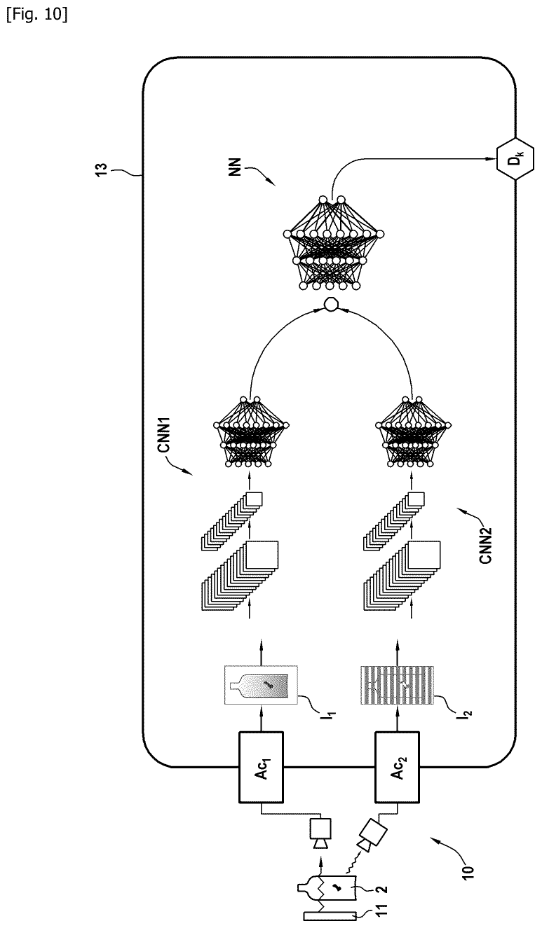

According to a first embodiment implemented in the exemplary embodiments of FIGS. 5 to 8, the analysis operations aim to method the analysis images so as to extract therefrom, in case of presence of a visible feature or an object, a region corresponding to this object. According to a second embodiment which will be described in detail in the exemplary embodiments of FIGS. 9 and 10, the image analysis operations do not aim to extract therefrom a candidate region but to take into account all or part of the analysis images according to the first modality and of the analysis images according to the second modality and/or according to the third modality.

One object of a digital analysis image is generally a set of related pixels having at least one common property that neighboring sets do not have. One object is therefore surrounded by a closed contour and is recognized as such solely from properties of the analysis image: properties for example photometric, gray level, intensity, texture, spatial frequency, contrast, color properties or any measurements of an optical property detected by the camera, etc.

One object corresponds to an area or region of an analysis image potentially presenting a glass defect. It is not mandatory for an object to be composed of a single image region closed by a single contour, because an object can be formed by several disjoint parts. Thus, a region can encompass the different disjoint parts of the same object if they are close. If they are far apart, it can be considered that two distinct regions form the same object. A region with an object, also called candidate region, presents an object that can be ranked as belonging to a class of objects among the list of possible classes as defined above.

The operations of analyzing the analysis images according to the various modalities implement one or more image processing operations by any type of digital processing known per se, such as for example thresholding, histogram correction, convolution operations or binary or grayscale mathematical morphology operations, carried out in such a way as to extract all the regions with an object. Such image processing operations known to those skilled in the art can be applied during the operations of calculating C1, C2 the analysis images, either during the analysis before the matching MC, or for example in the segmentation step SR described below.

Thus, the method implements an operation SR1 of segmenting and detecting candidate regions on the analysis images according to the first modality, an operation SR2 of segmenting and detecting candidate regions on the analysis images according to the second modality and an operation SR3 of segmenting and detecting candidate regions on the analysis images according to the third modality (FIGS. 5, 7 and 8). According to the exemplary embodiment illustrated in FIG. 6, an operation SR of segmenting and detecting candidate regions is carried out on a merged analysis image IF of an analysis image according to the first modality and an analysis image according to the second modality, as will be explained in the remainder of the description.

A segmentation operation conventionally consists in cutting the image into regions or segments, that is to say, assigning to the pixels a belonging to a region. This segmentation operation aims to determine the candidate regions in each analysis image, by filtering, thresholding, contour tracking, operations, etc. with a view generally but not necessarily to measuring parameters that characterize these regions. This image segmentation operation is carried out according to a filtering method adapted to the implemented modality or to the merged image IF.

These segmentation operations SR1, SR2, SR3, SR make it possible to detect candidate image regions defined by their outline limited to the object, these candidate image regions RC1, RC2, RC3 and RCC being respectively analysis images according to the first modality, analysis images according to the second modality, analysis images according to the third modality or merged images according to at least two modalities. It is also possible that these segmentation operations SR1, SR2, SR3, SR make it possible to detect candidate image regions defined by their rectangle framing the object RE1, RE2, RE3, REC, these candidate image regions being respectively analysis images according to the first modality, analysis images according to the second modality, analysis images according to the third modality or merged images according to at least two modalities. It is also possible that these segmentation operations SR1, SR2, SR3, SR make it possible to detect candidate image regions defined by their enlarged rectangle framing the object RL1, RL2, RL3, RLC, so as to take into account during the classifying, the context of the object in the image, these candidate image regions being respectively analysis images according to the first modality, analysis images according to the second modality, analysis images according to the third modality or merged images according to at least two modalities.

The method according to the invention implements for each container, an operation MC of matching the candidate regions in the analysis images of the first modality, the second modality or the third modality, with the corresponding regions of the analysis images of at least one other modality. The method can also implement for each container a matching of candidate regions of two different modalities.

This matching operation MC aims to ensure a matching of the regions in the analysis images of at least two different modalities by comparing their respective positions on the container. In the most general case, a geometric transformation is determined from one analysis image to the other, which allows, starting from a region or a pixel of a container analysis image, locating a region or a pixel of the other analysis image corresponding to the same region or elementary part of the container. The geometric transformation is of any necessary type and includes, for example, a translation/rotation, an anamorphosis, a change of scale, etc.

When the two different analysis images Ib, Ir or Ia of the same container 2 are delivered by two different cameras with two different objective lenses, it is possible to determine the geometric transformation linking two by two the regions or pixels of the two analysis images Ib, Ir or Ia corresponding to the same region of the wall of the container, by taking into account the three-dimensional geometry of the container 2, its position relative to the cameras 12, 12a at the time of acquisition of the images and the geometric and optical parameters of the inspection system 10, such as the direction of the optical axis, the position of the optical center and the focal length of the objective lenses of the cameras 12, 12a, these parameters determining the optical projection of the container by the objective lenses of the cameras on the planar image sensors.

According to one variant of embodiment, a pixel-by-pixel matching of analysis images of two different modalities of a container or of analysis image regions of two different modalities of a container is carried out. To do so, the geometric transformation is determined for all the pixels. It is also possible to calculate for one of the two analysis images, or portion of analysis image, a transformed image superimposable on the other image or portion of image. The geometric transformation and interpolations, for example bilinear interpolations, of the pixel values are then applied to all the pixels of the concerned region.

In the case where the analysis images of the different modalities match pixel-by-pixel due to the inspection system 10, the matching is direct. This is the case in particular, as explained above, during the acquisition of a monochrome or color polarimetric composite image or of a color composite image.

According to another variant of embodiment, regions whose middle or center of gravity are close on the container, that is to say match or are neighbors by the geometric transformation are matched. Or regions, whose rectangles framing the object or enlarged rectangles framing the object intersect or overlap on the container in a certain proportion of given surface area, are matched.

Also, this matching MC can be carried out either from candidate regions to candidate regions, or from candidate regions to corresponding regions determined during the matching or from pixel to pixel as in the illustrated exemplary embodiment.

According to the exemplary embodiments illustrated in FIGS. 6 and 9, a merged image IF is made with matching of an image or portion of analysis image according to the first modality and an image or portion of analysis image according to the second modality and/or an image or portion an analysis image according to the third modality. The method thus ensures, as a matching, a merging of the analysis images according to the first modality and according to the second modality and/or the third modality to obtain the merged image IF.

The method then ensures a segmentation of the merged images to detect merged candidate regions.

The matching operation MC can concern all of the analysis images or only parts of these analysis images. This matching MC is done pixel by pixel as explained previously. To each pixel pc(x, y) of coordinates x, y of the composite image is assigned a value that depends on the modalities. This value is for example either a 16-bit scalar pc(x, y) with 8 absorption bits and 8 refraction or birefringence bits or a vector vc(x, y) whose components {vt(x, y), vr(x, y)} are each an absorption scalar and a refraction or birefringence scalar. The simplest consists in directly taking the value of a pixel of the analysis image in absorption and of a pixel of the image in refraction or birefringence image, matched with the pixel of the analysis image in absorption. However it is possible to construct each merged pixel from the combination of several neighboring pixels in the images, or from interpolated values.

It should be noted that in the examples described, a merged image IF corresponds to a merging, with matching, of the analysis images according to the first modality and according to the second modality and/or the third modality. According to one variant of embodiment not illustrated by the drawings, the merged image IF can be directly identical to a composite image delivered by a monochrome polarimetric composite image sensor, a color polarimetric composite image sensor or a color composite image sensor. In other words, it is possible to directly analyze as a merged image IF, a monochrome polarimetric composite image, a color polarimetric composite image or a color composite image.

According to the exemplary embodiments illustrated in FIGS. 5, 7 and 8, the matching is carried out from candidate regions to candidate regions. It is possible to carry out a registration of one image on the other in order to make the candidate regions coincide on the two images of different modality. It is also possible to directly search for the candidate regions located in the same area of the container.

The method according to the invention also aims to choose classification characteristics according to the first modality and classification characteristics according to the second modality and/or classification characteristics according to the third modality, and/or merged characteristics that take into account characteristics combining in a logical or mathematical manner analysis images according to the first modality and analysis images according to the second modality and/or analysis images according to the third modality. These classification characteristics according to the first, second and third modality are characteristics of position, size, shape (concavity, perimeter, surface, etc.) or values expressing the absorption and/or the refraction and/or the birefringence (photometry values such as average level, contrast, variance, textures, etc.).

According to the exemplary embodiments illustrated in FIGS. 5 and 6, the method according to the invention implements an operation EC1, EC2, EC of extracting the classification characteristics. According to the exemplary embodiment illustrated in FIG. 5, the method implements an operation EC1 of extracting the classification characteristics for the candidate region RC1, RE1, RL1 from the analysis images according to the first modality making it possible to define a vector Ct of dimension n representing n characteristics m1i obtained from the analysis image according to the first modality for each candidate region. Similarly, the method according to the invention implements an operation EC2 of extracting the classification criteria for the candidate region RC2, RE2, RL2 from the analysis images according to the second modality making it possible to define a vector Cr of dimension m representing m characteristics m2i obtained from the analysis image according to the second modality for each candidate region.

It should be noted that according to the exemplary embodiment illustrated in FIG. 5, the operation of matching MC the candidate regions RC1, RE1, RL1 of the analysis images according to the first modality with candidate regions RC2, RE2, RL2 of the analysis images with the second modality makes it possible to obtain a vector Cc of dimension n+m representing n+m characteristics m1i, m2i obtained for each candidate region matched between the analysis images according to the first and to the second modality.

In the exemplary embodiment illustrated in FIG. 6, the method according to the invention implements an operation EC of extracting the classification characteristics for the merged candidate region according to the first modality and according to the second modality RCC, REC or RLC, obtained after the segmentation operation SR. This extraction operation makes it possible to obtain a vector Cc of dimension n+m representing n+m characteristics m1i, m2i obtained for each candidate region matched between the analysis images according to the first modality and the analysis images according to the second modality or for the merged candidate regions or the composite candidate regions from a monochrome polarimetric sensor, a color sensor or a color polarimetric sensor.

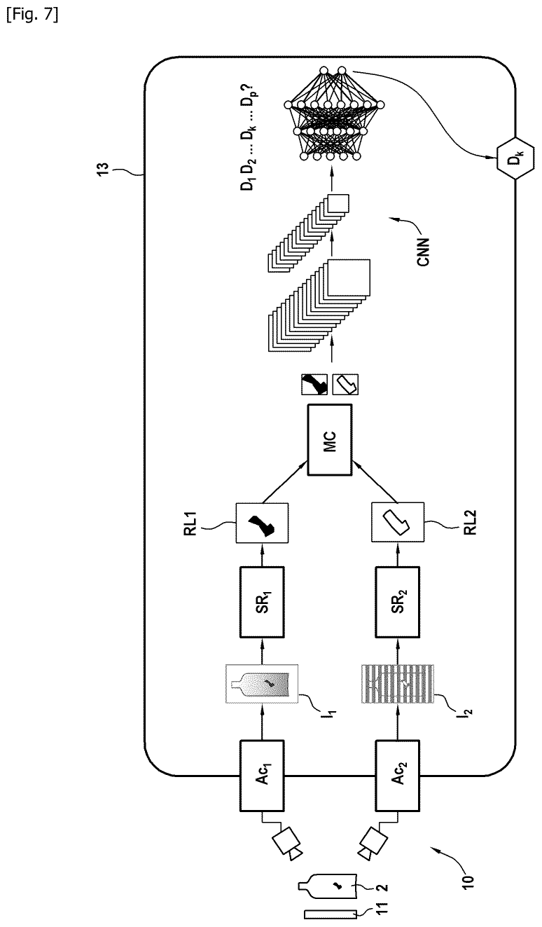

In the exemplary embodiments of FIGS. 5 and 6, the classification characteristics are determined by a preliminary analysis, namely professional knowledge or statistical studies. Image analysis algorithms determine the selected characteristics m1i, m2i of position, size, shape and photometry. In the exemplary embodiments illustrated in FIGS. 7 to 10, the classification characteristics are determined by supervised learning by being embedded in trained neural networks CNN, CNN1, CNN2, as described in the remainder of the description. Indeed, the role of the layers called convolution layers of the convolutional neural networks is able to determine by learning, parameters allowing the extraction of significant image characteristics for the classifying, then the extraction of said characteristics automatically during the classifying by the trained neural network. For example, the neural network used may be according to a model of the type known by the acronym RESNET or VGG or any other known network, these networks often being available in open source.

As an indication, the classifiers of the present invention can be implemented by neural networks, as indicated above, or alternatively by transformer-type models.

Using previously determined classification criteria applied to the classification characteristics, the method ranks the defects and consequently the containers bearing these defects. The classifying operation makes it possible to decide on the object class Dk of the candidate region or the container among the list of p possible classes D1, D2, ... Dp. If a candidate region is found in only one of the two images according to a first modality, an analysis of the defect is carried out according to the characteristics associated with the type of image exploited but also characteristics associated with the other modality are taken into account: an analysis based on the merging of the characteristics associated with the two types of images is carried out. The principle of the invention is based on taking into account the at least two inspection modalities to provide additional and reliable information to make the decision to classify the objects or containers, and therefore the identification of the defects. It is recalled that according to the methods of the prior art, when the information in a first modality makes it possible to detect a candidate region but when the information in a corresponding region of an image according to a second modality is very weak, then the information in the image according to the second modality is ignored and thus does not contribute to the classifying.

In accordance with the invention, the classifying operation is carried out by an image classifier having been trained by supervised learning. In the exemplary embodiments illustrated in FIGS. 5 and 6, the image classifier CI can be for example a support vector machine (SVM), a Bayesian classifier or a neural network NN. In the exemplary embodiments illustrated in FIGS. 7 and 10, convolutional neural networks CNN are implemented as image classifiers C1.

It should be understood that the method according to the invention aims to implement a step of learning the image classifier used for classifying the analysis images. This learning step is of course carried out prior to the step of implementing the image classifier for the classifying of the containers. This image classifier is trained by supervised learning that is to say by operations imposing on it the classifying to be carried out.

The image classifier Cl is trained by supervised learning methods consisting in determining parameters of the image classifier from a set of objects or images whose class is known, called learning set. According to this supervised learning method, the system is provided with sorted, labeled data, distributed according to a previously defined number of classes. Each data is associated, via sorting and labeling, with one of the said classes, which will allow the algorithm to calculate a more general model that will subsequently allow associating any unknown, unlabeled data with one of the previously defined classes. This supervised learning method differs from the unsupervised learning method (without a priori on the classes). According to this method, data are provided in bulk to the system, without any form of sorting or labeling. The system itself is responsible for defining the number of classes that it considers most relevant and associates one of the said classes with each data (example: X-Means clustering algorithm). The supervised learning method also differs from the unsupervised learning (with a priori on the number of classes): data are provided in bulk to the system, without any form of sorting or labeling. On the other hand, the number N of expected classes is indicated to the system. The system then automatically associates each data with one of the N expected classes (example: K-Means clustering algorithm).

The image classifier implemented within the framework of the invention for the inspection of containers has been trained on a learning set including recordings each composed of the images or image regions of the same container according to each modality associated with a class from the list of classes, so that the trained image classifier ranks the containers according to classification characteristics according to the at least two modalities. Of course, as explained above, the list of classes taken into account includes representations of at least glass defects.

Each recording of this learning set includes for one exemplary or reference container:
at least one analysis image according to the first modality and at least one analysis image according to the second modality and/or one analysis image according to the third modality matched together and at least one label assigning to the exemplary container, at least one class of objects among the list of possible classes or,
at least one analysis image region according to the first modality of the exemplary container, at least one image analysis region of the second modality and/or of the third modality of the exemplary container matched together and at least one label assigning to the corresponding region of the exemplary container at least the class of objects among a list of possible classes.

The learning set thus comprises pairs or triplets of matching regions, preferably pairs or triplets of characteristic vectors associated with a type of glass defect.

This image classifier that has been trained during a learning phase is used during the inspection of the containers, to ensure a classifying of the containers according to the input data applied to the image classifier and representative of the inspected containers. The information processing unit 13 is thus configured to ensure the execution or the implementation of the image classifier having been previously trained by supervised learning so that this trained image classifier ranks the containers.

According to the examples illustrated in FIGS. 5 and 6, the input data of the image classifier are the information of the vector Cc of dimension n+m representing the characteristics m1i, m2i obtained for each candidate region matched between the analysis images according to the first and the second modality. Generally, the classification characteristics according to the first modality and the classification characteristics according to the second modality and/or the classification characteristics according to the third modality are the input data of the image classifier.

According to the exemplary embodiment illustrated in FIG. 7, the image classifier which is a convolutional neural network CNN has as input data, a pair of candidate regions (RL1, RL2), obtained after the matching operation MC of these candidate regions.

According to the exemplary embodiment illustrated in FIG. 8, the image classifier includes a first convolutional neural network CNN1 having as input data, a candidate region according to the first modality (RC1, RE1, RL1) obtained after the operation SR1 of segmenting and detecting candidate regions on the analysis images according to the first modality. The image classifier also includes a second convolutional neural network CNN2 having as input data, a candidate region according to the second modality (RC2, RE2, RL2) obtained after the operation SR2 of segmenting and detecting candidate regions on the analysis images according to the second modality. The image classifier also includes a third convolutional neural network CNN3 having as input data, a candidate region according to the third modality (RC3, RE3, RL3) obtained after the operation SR3 of segmenting and detecting candidate regions on the analysis images according to the third modality.

The first convolutional neural network CNN1, the second convolutional neural network CNN2 and the third convolutional neural network CNN3 each work in parallel respectively on a candidate region in absorption, on a candidate region in birefringence and on a candidate region in refraction, these three regions according to the three modalities, being associated by the matching operation MC according to the techniques explained above.

The outputs of the first convolutional neural network CNN1, of the second convolutional neural network CNN2 and of the third convolutional neural network CNN3 are the input data of an image classifier for example of the SVM, Random Forest, Bayesian type, and preferably a neural network NN, allowing classification according to the three modalities. The outputs of the first convolutional neural network CNN1, of the second convolutional neural network CNN2 and of the third convolutional neural network CNN3 are for example assumptions of belonging classes but they can be more complex data with vectors of dimensions greater than the number p of classes. It is recalled that the learning set of the neural networks contains triplets of candidate regions according to the three inspection modalities, with as a label, an object class among the list of possible classes.

According to a second embodiment implemented in the exemplary embodiments of FIGS. 9 and 10, the image analysis operations do not aim to extract therefrom a candidate region but to take into account all or part of the analysis images according to the first modality and of the analysis images according to the second modality and/or according to the third modality, without the implementation of a prior segmentation operation. If only parts of images are analyzed, these parts preferably correspond to one or more regions of interest of the container such as the finish, the collar, the shoulder, the body, the chime or a right or left half-side or an area where engravings are present. According to these two exemplary embodiments illustrated in FIGS. 9 and 10, the analysis operations are based on the implementation of neural networks, as an image classifier trained by supervised learning.

In the exemplary embodiment illustrated in FIG. 9, an operation MC of matching an analysis image according to the first modality and an analysis image according to the second modality is performed in order to obtain a merged image IF. The fused image IF is obtained by merging of at least one analysis image according to the first modality with at least one analysis image according to the second modality of a container or by merging of regions of at least one image according to the first modality with corresponding regions of at least one image according to the second modality. In general, as already explained, the fused image IC is obtained by merging of at least one analysis image according to the first modality with at least one analysis image according to the second modality and/or one analysis image according to the third modality of a container or by merging of regions of at least one analysis image according to the first modality with corresponding regions of at least one analysis image according to the second modality and/or one analysis image according to the third modality. Similarly, the merged image IF can be directly identical to a composite image delivered by an image sensor.

The analysis images according to the various modalities are taken during the acquisition operations Ac1, Ac2 carried out by the inspection system 10, as explained in the description above. This matching MC of the pixel-to-pixel images is carried out as explained in the exemplary embodiment of FIG. 6. This merged image is used as input data for a convolutional neural network CNN which is able, by supervised learning, to take into account the position, size, shape and photometry characteristics which are significant for the intended classification. It is recalled that the learning set contains merged images IF or regions of merged images with as a label, a class of objects among the list of possible classes. The classification characteristics according to the various modalities are taken into account in the weights resulting from the learning and defining the convolutional neural network CNN. It should be noted that unlike the examples in FIGS. 6 and 7, the segmentation operation is not necessary in this variant because the steps of the convolutional neural network are able, through learning, to classify the images according to their content without prior segmentation, and to locally determine the position, size, shape and photometry characteristics that are significant for the classification. But a segmentation operation is possible for example by replacing in FIG. 6 the characteristic extraction EC and the image classifier CL with an image classifier based on a convolutional neural network CNN.

In the exemplary embodiment illustrated in FIG. 10, the analysis image according to the first modality (in part or in whole) is used as input data for a first convolutional neural network CNN1 while the analysis image according to the second modality (in part or in whole) is used as input data for a second convolutional neural network CNN2. As explained above, these convolutional neural networks have been previously trained by supervised learning in order to be able to determine the morphology characteristics such as position, size, shape and photometry which are significant for the intended classification.

The first convolutional neural network CNN1 and the second convolutional neural network CNN2 each work in parallel on two candidate images in each modality. The outputs of the first convolutional neural network CNN1 and of the second convolutional neural network CNN2 are the input data of a classifier for example of the SVM, Random Forest, Bayesian type, and preferably a neural network NN, allowing the classification of the containers according to the two modalities. It should be noted that the two candidate images in each modality on which the first convolutional neural network CNN1 and the second convolutional neural network CNN2 work are associated by a matching operation.

The outputs of the first convolutional neural network CNN1 and of the second convolutional neural network CNN2 are for example assumptions of belonging classes but they can be more complex data with vectors of dimensions greater than the number p of classes. It should be noted that unlike the example in FIG. 8, the segmentation operation is not necessary in this variant because the stages of the convolutional neural network are able by learning to classify the images according to their content without prior segmentation, and to locally determine the morphology characteristics, for example, position, size or shape and photometry characteristics which are significant for the classification.

It appears from the description above that the method according to the invention not only makes it possible to identify in transmission the glass defects of the containers but also to classify these defects to allow moving from the inspection to the optimization of the manufacturing process. One of the characteristics of the invention is to define a class list including classes of defects, which makes it possible to relate the glass defects to characteristics of the manufacturing process to be regulated. The improvement of the classification of the glass defects makes it possible to better trace back the causes of the glass defects.

The object of the invention is advantageously exploited within the framework of the manufacturing facilities to allow better detection and categorization of the defects present within the containers. Some defects can be seen, detected and categorized more easily thanks to the combination of the two or three modalities.

Preferably, the inspection method according to the invention is designed so that the image classifier associates a confidence score with the classifying of the containers resulting from a production. The confidence score is typically the probability that the container belongs to the belonging class. The score can be expressed as a % or a value between 0 and 1.

It should be noted that a container can include several defects. There are several manners to classify such containers. In the variants of the method that include a segmentation step, analysis images of the same container can be extracted, several image regions and for example several segments SR are recognized as belonging to defect classes. In this case, according to a first variant, the belonging class of the container will be that of the segment ranked in the defect class with the highest criticality. It is also possible to take into account the confidence score of the classifying, that is to say the class assigned to the container will be that of the segment ranked with a confidence score higher than the confidence threshold. According to a second variant, all the defects carried by a single container can be counted, in particular when a container carries several critical defects. Thus the statistical analysis of the production which will be presented later, can account for the distribution of the defects independently of the number of containers rejected.

The object of the invention is exploited for the sorting of the production of containers in the following manner. After classifying of a container, at least one container sorting characteristic is compared with a rejection criterion, and when the sorting characteristic exceeds the rejection criterion for a container, the container is considered non-compliant and rejected. Indeed, the facility includes an ejector for removing the defective containers from the production. The sorting characteristic and the rejection criterion are dependent on the belonging class to decide whether or not the container is compliant, the sorting characteristic being calculated on at least one image of the container according to one of the two or three modalities. The sorting characteristic and the rejection criterion are for example a defect dimension such as its surface or its length measured in at least one analysis image. The confidence score can be possibly taken into account for the sorting, by rejecting containers belonging to a low-critical defect class only if the confidence score is high and conversely by rejecting containers belonging to a critical defect class even if the confidence score is low.

The object of the invention is exploited to carry out a statistical analysis of a container production, that is to say an analysis of the frequency or distribution of the different types of defects and their criticality, the types of defects included in the list of classes and their criticality being determined in advance for the purposes of monitoring the process.

Some defects are caused during the steps of forming the containers in the molds, and are therefore to be related to the forming parameters that are different from one section to another or from one cavity to another. It is therefore preferable to count the defect classes according to the original section or cavity of the containers. When the facility is installed at the outlet of the forming machines, therefore upstream of the annealing lehr 6, the inspection is immediate after manufacturing so the timestamp of the container manufacturing is known and, by synchronization, the original cavities or sections of the containers are also known since the order in which the containers leave the forming machine is known. When the inspection device 1 in accordance with the invention is installed downstream of the annealing lehr 6, it is preferably equipped with a device for reading information carried on the containers and indicating the mold or the original section of the containers and/or a time stamp of their manufacture, or connected to such a reading device. It is therefore possible and preferable to carry out the statistical analysis of the production, from the classifying of the containers by the inspection process, according to the distribution of the defects in direct relation to the production parameters at the time of manufacture of each container and/or according to the different cavities and sections of the manufacturing machine.

The statistical analysis of the production of the containers thus makes it possible to relate the defects to their causes, in order to obtain two results:
on the one hand, correlations can be determined between the manufacturing parameters and the resulting defects, thus making it possible to define more efficient regulation methods of the process;
on the other hand, knowing the cause-effect relationships, the possibility of making a feedback loop is delivered in real time to the production calculator 7, to regulate the method by correcting the defects and therefore the gaps between the desired quality and the estimated quality of the containers.

To summarize the above, the object of the invention is advantageously exploited for various production operations described below:
sorting the production;
statistically analyzing the production;
determining the cause-and-effect relationships between production parameters and defects;
monitoring the method by reducing the defects observed;
warning the operators of the occurrence of critical defects by an alarm.

According to one preferred variant of the invention, the classifying of the containers is only taken into account when the confidence score of the assigned class exceeds a confidence threshold in order to:
count the defects by defect class in a defect frequency statistics,
and/or decide to reject the container,
and/or trigger an alarm of presence of one or more critical defects in the inspected production.

It should be noted that the confidence threshold corresponds to a predetermined or adjustable minimum value of the confidence score.

Taking these various modalities into account by a supervised learning classification algorithm makes it possible to automatically manage both the different aspects of the light/matter interactions (absorption, birefringence, refraction) but also the coupling of these interactions that result from the analysis images obtaining methods. Through the supervised learning, the image classifier takes into account the photometric and morphological characteristics in both modalities or even in all three modalities. The image classifier is thus able, through learning, to determine the geometric and photometric characteristics that are significant for the intended classification. Also, such an image classifier is able, during inspection, to associate the unknown and unlabeled image data with a previously defined class.

The method according to the invention is thus distinguished from the classification methods of the prior art whose classification procedure is based solely on physical or logical considerations, applying predefined business rules. Conversely, the image classifier implemented according to the invention makes it possible to construct, by itself, the association model between the input data and the class. Given the supervised learning, it is the image classifier that will directly associate the input data with a class taken among the list of classes.

1. A method for inspecting glass containers so as to classify a container, the method including the following steps:
inspecting each container using an inspection system including at least one light source illuminating the container and at least one camera disposed to recover the light having crossed the container, so as to acquire images of at least part of the container illuminated in transmission, so as to obtain at least one analysis image according to a first modality corresponding to an absorption image and at least one analysis image according to a second modality corresponding to a birefringence image or to a refraction image,
defining a list of classes including at least glass defects, the list of classes including a number of classes independent of the number of modalities;
ensuring a matching of at least part of an analysis image according to the first modality and at least part of an analysis image according to the second modality,
from at least one analysis image according to the first modality and at least one analysis image according to the second modality, matched together, classifying the analysis images by means of an image classifier that determines to what result class among the list of classes they belong,
the image classifier having been trained by supervised learning, on a learning set including recordings each composed of the images or image regions of the same container according to each modality, matched together and associated with a class from the list of classes, so that the trained image classifier ranks the containers according to classification characteristics according to the at least two modalities; and
classifying the container according to the result class.

2. The method according to claim 1, wherein the method includes the following steps:
inspecting each container using the inspection system configured to acquire images so as to obtain at least one analysis image according to the first modality, at least one analysis image according to the second modality and at least one analysis image according to a third modality, the analysis image according to the second modality corresponding to a birefringence image while the analysis image according to the third modality corresponds to a refraction image,
ensuring a matching of at least part of an analysis image according to the first modality, at least part of an analysis image according to the second modality and at least part of an analysis image according to the third modality,
from at least one analysis image according to the first modality, at least one analysis image according to the second modality and at least one analysis image according to the third modality matched together, classifying the analysis images by means of an image classifier that determines to what result class among the list of classes they belong,
the image classifier having been trained by supervised learning, on a learning set including recordings each composed of the images or image regions of the same container according to each modality, matched together and associated with a class from the list of classes, so that the trained image classifier ranks the containers according to the classification criteria according to the at least three modalities;
classifying the container according to the result class.

3. The method according to claim 1, wherein the method aims to inspect the containers using the inspection system configured to obtain analysis images corresponding to absorption images, birefringence images and/or refraction images according to one of the following manners:
acquire images and calculate, from several of these images, analysis images corresponding to absorption images, birefringence images and/or refraction images,
acquire polarimetric composite images and calculate, from these polarimetric composite images, absorption images, and/or birefringence images and/or refraction images,
acquire, using a color camera, color composite images and calculate, from these color composite images, absorption images and refraction images,
acquire images corresponding directly to absorption images, birefringence images and/or refraction images.

4. (canceled)

5. (canceled)

6. (canceled)

7. The method according to claim 1, according to which, in order to ensure the matching of at least part of an analysis image according to the first modality and at least part of an analysis image according to the second modality and/or at least part of an analysis image according to the third modality, the method detects candidate regions in the analysis images of the first modality and in the analysis images of the second modality and/or in the analysis images of the third modality, the method ensuring, for each container:
a matching of the candidate regions in the analysis images of the first modality, the second modality or the third modality, with the corresponding regions of the analysis images of at least one other modality, or
a matching of candidate regions of two different modalities.

8. The method according to claim 1, according to which the method ensures, as a matching, a merging of at least one analysis image of the first modality and an analysis image of the second modality and/or an analysis image of the third modality to obtain a merged image, the method ensuring:
an extraction of classification characteristics from the merged image, and
classifying of the container using classification criteria applied to the classification characteristics of the merged image.

9. The method according to claim 1, according to which the method ensures, as a matching, a merging of at least one analysis image of the first modality and an analysis image of the second modality and/or the third modality to obtain a merged image, the method ensuring:
a segmentation of the merged images to detect merged candidate regions, and
a classifying of the container using classification criteria applied to the characteristics of the merged candidate regions.

10. The method according to claim 1, wherein:
classification characteristics according to the first modality are extracted from the analysis images according to the first modality,
classification characteristics respectively according to the second modality and according to the third modality are extracted from the analysis images according to the second modality and/or from the analysis images according to the third modality,
the container is ranked using classification criteria applied to the characteristics according to the first modality and the second modality and/or the third modality.

11. The method according to claim 10, according to which classification characteristics according to the first modality and classification characteristics according to the second modality and/or classification characteristics according to the third modality, and/or merged characteristics that take into account characteristics logically or mathematically combining analysis images according to the first modality and analysis images according to the second modality and/or analysis images according to the third modality are chosen, these classification characteristics according to the first, the second and the third modality being characteristics of position, size, shape or values expressing the absorption and/or the refraction and/or the birefringence.

12. The method according to claim 1, according to which the container is ranked by a supervised learning image classifier whose input data are:
the classification characteristics according to the first modality and the classification characteristics according to the second modality and/or the classification characteristics according to the third modality,
or the analysis images according to the first modality and the analysis images according to the second modality and/or the analysis images according to the third modality,
or parts of the analysis images according to the first modality and parts of the analysis images according to the second modality and/or according to the third modality.

13. The method according to claim 1, according to which the container is ranked by a supervised learning image classifier whose input data are at least one merged image obtained by merging of at least one analysis image according to the first modality and one analysis image according to the second modality and/or one analysis image according to the third modality or by merging of regions of at least one analysis image according to the first modality and one analysis image according to the second modality and/or one analysis image according to the third modality.

14. The method according to claim 1, according to which each container is ranked according to at least one class taken among a list of classes representing at least glass defects such as, in particular, trapezoid, inclusion, bubble.

15. The method according to claim 1, according to which at least one sorting characteristic is compared with a rejection criterion, the sorting characteristic and the rejection criterion being dependent on the belonging class to decide whether the container is compliant or not, the sorting characteristic being calculated on at least one image of the container according to one modality.

16. The method according to claim 1, according to which a step of taking into account at least one identified glass defect is implemented to deduce therefrom adjustment information for at least one monitoring parameter of a container manufacturing facility.

17. The method according to claim 1, according to which:
the image classifier associates a confidence score with the classifying of the containers that form part of an inspected production;
the classifying of the containers is taken into account only when the confidence score exceeds a confidence threshold to;
count the defects by class of defects;
and/or decide on the rejection of the container;
and/or trigger an alarm of presence of at least one critical defect in the inspected production.

18. A device for inspecting glass containers leaving a manufacturing facility so as to classify the containers in relation to glass defects, the device including:
an inspection system including at least one light source illuminating the container and at least one camera disposed to recover the light having crossed the container, so as to acquire images of at least part of the container illuminated in transmission by the light source,
an information processing unit connected to the inspection system and adapted to provide for each container, at least one analysis image according to a first modality corresponding to an absorption image and at least one analysis image according to a second modality corresponding to a birefringence image or to a refraction image, this information processing unit being configured to carry out operations:
of taking into account a list of classes including representations of at least glass defects, the list of classes including a number of classes independent of the number of modalities;
of matching at least part of an analysis image according to the first modality and at least part of an analysis image according to the second modality,
from at least one analysis image according to the first modality and at least one analysis image according to the second modality, matched together, of classifying the analysis images by means of an image classifier that determines to what result class among the list of classes they belong,
of taking into account the image classifier having been trained by supervised learning, on a learning set including recordings each composed of the images or image regions of the same container according to each modality, matched together and associated with a class from the list of classes, so that the trained image classifier ranks the containers according to classification characteristics according to the at least two modalities;
of classifying the container according to the result class.

19. The device according to claim 18, according to which the inspection system is configured to acquire polarimetric composite images while the information processing unit is configured to calculate from these polarimetric composite images, absorption analysis images, and/or birefringence analysis images and/or refraction analysis images.

20. The device according to claim 18, according to which the inspection system is configured to acquire images while the information processing unit is configured to calculate from several of these images, absorption analysis images, and/or birefringence analysis images and/or refraction analysis images.

21. The device according to claim 18, according to which the inspection system is configured to acquire color composite images using a color camera while the information processing unit is configured to calculate from these color composite images, absorption images and refraction images.

22. The device according to claim 18, according to which the inspection system is configured to acquire images corresponding directly to absorption images, birefringence images and/or refraction images.
